(19) United States
(12) Patent Application Publication
(10) Pub. No.: US 2009/0241101 A1
(43) Pub. Date: Sep. 24, 2009

(54) CLIENT SYSTEM AND METHOD FOR MANAGING A SOFTWARE VERSION THEREOF

(75) Inventors: KIM Won-Young, Daejeon (KR); Shim Jeong-Min, Daejeon (KR); Choi Wan, Daejeon (KR); Seo Gyu Hyun, Daejeon (KR)

Correspondence Address: AMPACC LAW GROUP, 3500 188th St. SW, Lynnwood, WA, 98037, US

(73) Assignee: Electronics and Telecommunications Research Institute, Daejeon (KR)

(21) Appl. No.: 12/477,128

(22) Filed: Jun. 3, 2009

Related U.S. Application Data
(63) Continuation of application No. PCT/KR2007/006231, filed on Dec. 4, 2007.

(30) Foreign Application Priority Data
Dec. 4, 2006 (KR) 10-2006-0121313
Oct. 24, 2007 (KR) 10-2007-0107264

(51) Int. Cl. G06F 9/44

(52) U.S. Cl. 717/170

(57) ABSTRACT

A streaming client system for managing multiple versions of a software program and a software version management method thereof are provided. An executable page storage storing executable pages of a previous version only corresponded to the previous version or shared by the previous version and a new version, and executable pages added or modified in the new version, An executable page searcher searching and providing a necessary executable page with reference to executable pages of the previous version when a software program of the previous version is executed, and searching and providing the necessary executable page with reference to both the shared executable pages and the added or modified executable pages when the software program of the new version is executed. Transmission overhead is minimized, a storage area is optimized, and software version can be updated without service interruption.

### TECHNICAL FIELD

The present invention relates to a software version management method, and more particularly, to a streaming client system for managing multiple versions of software program provided under a software streaming environment, and a software version management method thereof.

This work was supported by the ITR & D program of MIC/IITA [2005-S-007-02, A Development of Open Software Based On-Demand Officeware Deployment Technologies].

### BACKGROUND ART

Software streaming service is a technology to stream the code of a software program (or application program) from a streaming server and execute it on a streaming client in real-time without downloading and installation of the software program.

In order to provide the software streaming service, the streaming server has to perform a software program packing process for providing the software program, and the streaming client caches the streamed software program in order to improve quality of service.

FIG. 1 is a conceptual view illustrating the operation of a software streaming system according to the previous art, in which a streaming server 120 transmits streaming data to a streaming client 110 in order to provide a software streaming service.

A streaming client 110 connect with the streaming server 120 and requests executable pages (or executable codes) of a software program to be executed. The streaming server 120 searches for and acquires the requested pages from the application packages 130 and provides the acquired executable pages to the streaming client 110.

In this way, the streaming client 110 can receive the executable pages of the software program from the streaming server 120 and execute the software program as if installed in the local system thereof without downloading and installing.

Here, in order to speed up a software program execution, the streaming client 110 temporarily stores the executable page streamed from the streaming server 120 in a cache.

Generally, since software programs are always updated, there are multiple versions for the same software program.

FIG. 2 is a view illustrating executable code of the previous art, which provide two versions of a software program.

Referring to FIG. 2, an executable code 210 includes execution files necessary to execute a version 1.0 (SW V1.0) of the software program, and an executable code 220 includes execution files necessary to execute another version 1.1 (SW V1.1) of the software program.

In this case, however, it can be understood that the executable code 210 of the SW V1.0 and the executable code 220 of the SW V1.1 are composed of the same executable files except for /sw/sw1.dat 221 and /sw /config /back /dat files 222.

### DISCLOSURE

### Technical Problem

According to the previous art as above, a streaming client should receive the whole executable code of a new version from a streaming server although the streaming client already received and cached the partially redundant code of the previous version. The previous art not only has transmission overhead but also has storage overhead caused by the redundant code.

Furthermore, when a user attempts to replace the previous version with a new version, a software streaming service of the new version can be started after then that of the previous version should be stopped and/or the executable code of the previous version should be removed.

### Technical Solution

According to an aspect of the present invention, there is provided a streaming client system comprising: an executable page storage for sharing common executable pages of a prior version and a new version, additionally streaming and storing executable pages added or modified in the new version in order to support execution of software program having multiple versions; and an executable page searcher for searching and providing executable pages of the prior version for a necessary executable page during execution of prior version of software, and searching and providing the shared common executable pages and the added or modified executable pages for a necessary executable page during execution of a new version of software.

According to another aspect of the present invention, there is provided a streaming client system comprising: an executable page storage for sharing common executable pages of a prior version and a new version, additionally storing executable pages added or modified in the new version of software, and deleting part of executable pages which are used only in the prior version, in order to support only the new version; and an executable page searcher for searching the executable pages for a necessary executable page to execute the new version of software.

According to a further aspect of the present invention, there is provided a software program version management method of a streaming client system, comprising: (a) streaming executable pages of a prior version in order to service the prior version of software; (b) in response to a request for addition of a new version of software, sharing common executable pages of the prior version and the new version, additionally streaming and storing executable pages added or modified in the new version; and (c) executing the prior version of software program with reference to the executable pages of the prior version or executing the new version of software program with reference to both the shared executable pages and the added or modified executable pages.

According to yet another aspect of the present invention, there is provided a software program version management method of a streaming client system, comprising: (a) streaming executable pages of a prior version of software, which are necessary for servicing the prior version; (b) sharing part of the executable pages of the prior version which are in common with a new version of software, additionally streaming and storing added or modified executable pages of the new version; and (c) deleting part of the executable pages of the prior version which are necessary for executing only the prior version after terminating execution of the prior version of software.

### Advantageous Effects

According to the invention as set forth above, the streaming client system and the software version management method thereof share most of the executable pages of a previous version and additionally receive only a specific part of the information of changed or added files via streaming in order to update the version of a software program.

Accordingly, the transmission overhead can be prevented and the streaming client can use a storage area with improved efficiency. Furthermore, the software programs can be updated without interruption of the previous version program service.

### DESCRIPTION OF DRAWINGS

FIG. 1 is a conceptual view illustrating the operation of a software streaming system of the previous art;

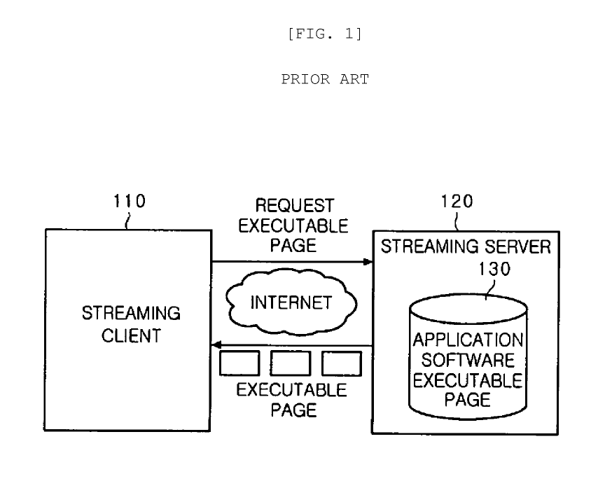

FIG. 2 is a view illustrating executable pages of the previous art, which provide two versions of a software program;

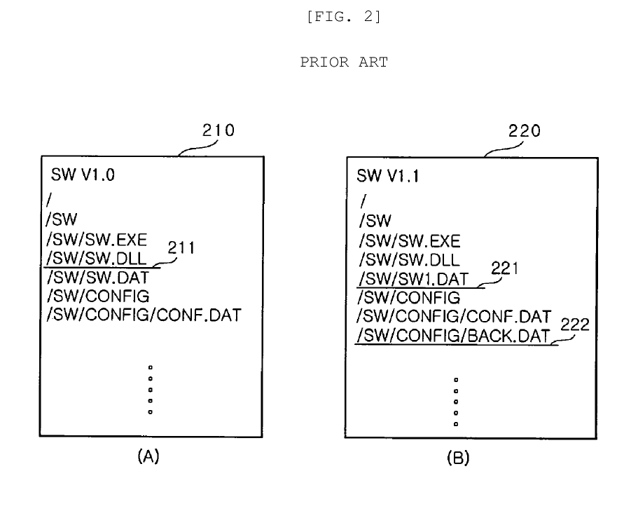

FIG. 3 is a block diagram illustrating the architecture of a streaming client system according to the invention;

FIG. 4 is diagram illustrating the structures of the executable page provider according to the invention;

FIG. 5 is a flowchart illustrating a software version management method according to an embodiment of the invention; and

FIG. 6 is a flowchart illustrating a software version management method according to another embodiment of the invention.

### BEST MODE

Hereinafter the present invention will be described more fully with reference to the accompanying drawings, in which exemplary embodiments thereof are shown, so that those skilled in the art can more clearly understand the invention. In the following description of the present invention, a detailed description of known functions and components incorporated herein will be omitted when it may make the subject matter of the present invention rather unclear.

Reference now should be made to the drawings, in which the same reference numerals or symbols are used throughout the different drawings to designate the same or similar components.

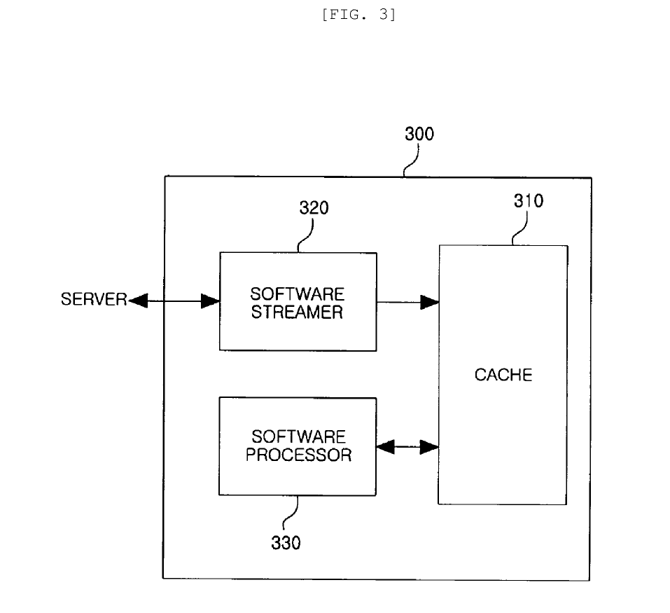

FIG. 3 is a block diagram illustrating the architecture of a streaming client system 300 according to the invention.

Referring to FIG. 3, the streaming client system 300 includes an executable page provider 310, a software program streamer 320 and a software program processor 333. The executable page provider 310 includes an executable page searcher 311 and an executable page storage 312, and inputs and outputs the executable pages using a cache technique.

In the case of software program update, the executable page provider 310 composes executable pages of a new version by reusing preexisting executable pages, which were streamed for a previous version of the software program.

That is, when a software program is streamed for the first time, first executable pages thereof are entirely streamed down and then stored. However, in the case of the software program is updated, entire executable pages of a new version are not streamed down. Rather, only second executable pages, having different information from the previous version of the software program, are streamed down and stored, and part of the first executable pages of the previous version in common with the new version are shared.

In the case of deleting the previous version to support only the new version, part of the executable pages of the previous version, which are only necessary for executing the previous version, are deleted. That is, except for first and second executable pages, which are necessary to execute the new version, the rest of the executable pages are deleted in order to improve the efficiency of a memory.

When the software program streamer 320 detects a user request, it connects with a streaming server and receives a program code streamed therefrom, and controls the operation of the executable page provider 310.

More particularly, when the user requests an execution of the software program, the software program streamer 320 checks whether a previous version of the software program is present in local system or not. If the previous version is not present, the software program streamer 320 receives entire first executable pages from the streaming server. On the other hand, if the previous version is present, the software program streamer 320 connects with the streaming server and confirms whether the version of the software program is updated or not. If the version of the software program is updated, the software program streamer 320 receives second executable pages which is corresponding to a new version and added or modified with respect to the previous version.

When the user makes a request to delete the previous version in order to use only the new version, the software program streamer 320 notifies the delete request to the executable page provider 310, so that the executable pages corresponding to only the previous version can be deleted.

The software program processor 333 executes the previous version of the software program with reference to first executable pages only, and executes the new version of software program with reference to first and second executable pages.

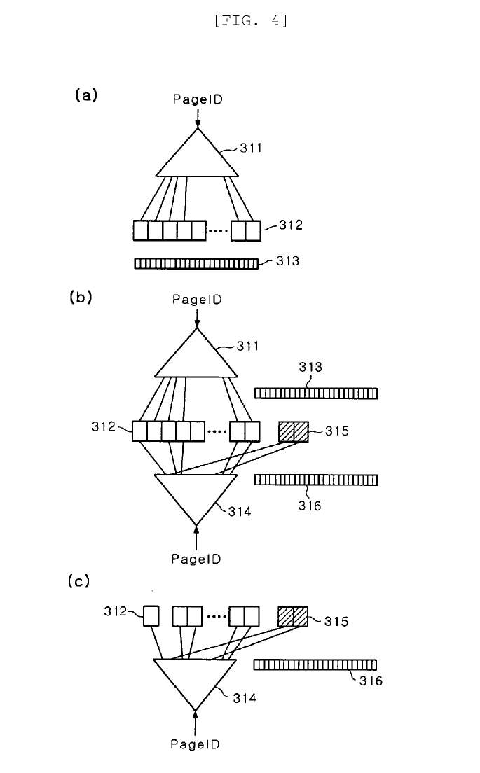

FIG. 4 is diagram illustrating the structures of the executable page provider according to the invention, in which (a) shows the structure in the case where only a previous version of a software program is present, (b) shows the structure in the case where the previous version is present together with a new version, and (c) shows the structure in the case where only the new version is present.

First, referring to (a), when only the previous version is present, the executable page storage 312 of the executable page provider 310 includes first executable pages 312-1 corresponding to the previous version and first streaming state information 312-2 informing respective streaming state of the first executable pages 312-1. The executable page searcher 311 comprises only a first executable page searcher 311-1, which searches the first executable pages 312-1 to be necessary for executing the previous version.

That is, when the software program is executed and streamed for the first time, the first executable page searcher 311-1 and the first streaming state information 312-2 are generated and then initialized.

Next, when the first executable pages 312-1 are received, the first streaming state information 312-2 corresponding to the received executable pages is changed from “0” to “1,” and the received executable pages 312-1 are added through the first executable page searcher 311-1.

In this state, when a new version is added and streamed, the structure of the executable page provider 310 is changed as shown in of (b).

That is, when the new version is streamed, a second executable page searcher 311-2 and second streaming state information 312-4, which in common correspond to the first and second executable page 312-1 and 312-3, are additionally generated. And then information of the first streaming state information 312-2 and the first executable page searcher 311-1 is reflected for a corresponding one of the second executable page searcher 311-2 and the second streaming state information 312-4, respectively.

When the executable pages 312-3 are received, the streaming state information 312-4 corresponding to the received executable pages 312-3 are changed from “0” to “1,” and the received executable pages 312-3 are added through the executable page searcher 311.

In this state, when the previous version is deleted so that only the new version can be used, the structure of the executable page provider 310 is changed again as shown in (c).

When a request to delete the previous version of the software program is made, the first streaming state information 312-2 and the first executable page searcher 311-1 are deleted, and part of first the executable pages 312-1, which have been used by only the first executable page searcher 311-1, are also deleted. That is, a part of the executable pages, which are necessary to execute only the previous version, are deleted.

Accordingly, there remain the second executable page searcher 311-2, the second executable pages 312-3 and the second streaming state information 312-4 of the new version and the first executable pages 312-1′ of the previous version which are necessary for executing the new version.

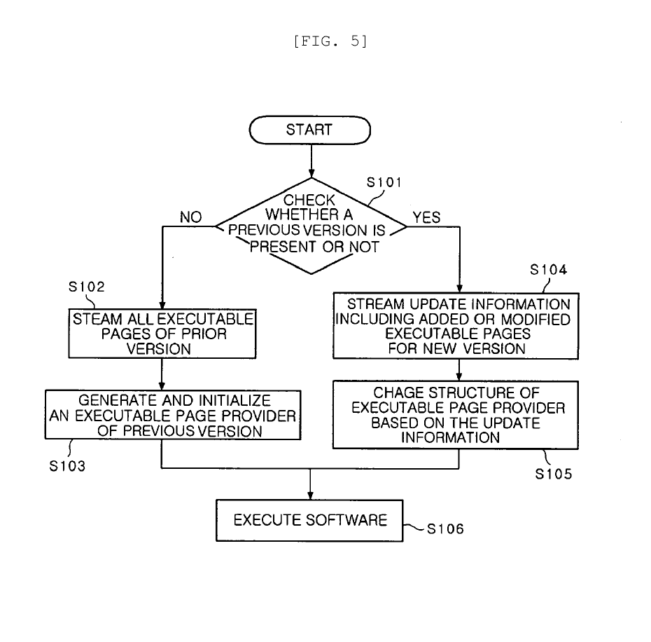

FIG. 5 is a flowchart illustrating a software version management method according to an embodiment of the invention, by which a streaming client can service multiple versions of software program.

When a user makes a request for a software program service, the streaming client checks whether a previous version of software program is present in local system thereof or not, in S101.

If the previous version is not present in the streaming client, that is, it is the first time to execute the software program, the streaming client receives an initial streaming information including all executable pages of the previous version streamed from streaming server, in S102.

And then, the streaming client generates an executable page provider 310 having a structure as shown in (a) of FIG. 4 based on the initial streaming information and initializes the executable page provider 310 in S103. In S106, the streaming client acquires necessary executable pages using the executable page provider 310 and executes the previous version of software program based on the acquired executable pages.

On the contrary, if the previous version of the user requested-software program is present in the streaming client, the streaming client provides the currently used version number to the streaming server and brings update information including added or modified executable pages in a new version from streaming server, in S104.

In S105, the structure of the executable page provider 310 is changed as shown in (b) of FIG. 4 based on the executable page provider 310 generated in the step S103 and the update information, received from the streaming server.

In S106, necessary executable pages are acquired using a new page searcher 314 and the software program is executed based on the acquired executable pages.

Accordingly, the invention can prevent generation of transmission overhead and also minimize consumption of a storage area in order to store multiple versions of software program.

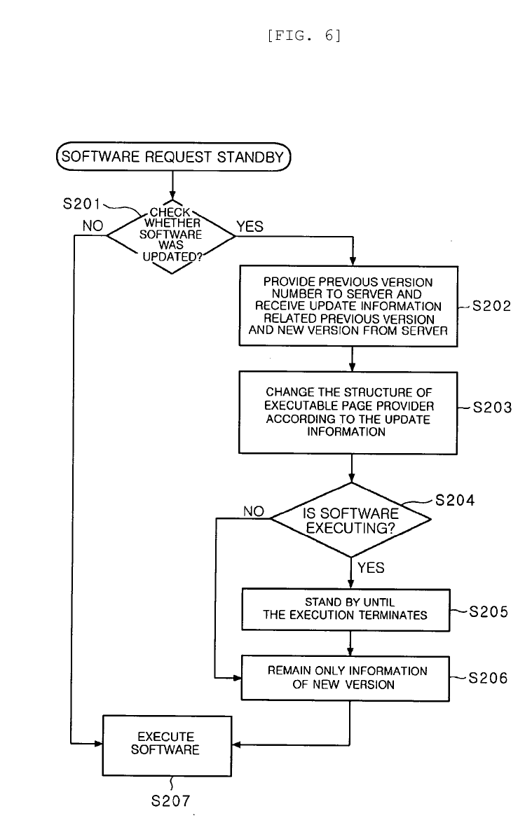

FIG. 6 is a flowchart illustrating a software version management method according to another embodiment of the invention, by which a streaming client can service only a new version of software program.

When a user makes a request for a software program service, the streaming client notifies a previous version of software program to a streaming server and checks whether software program has been updated or not through the streaming server, in S201.

If there is no new version, the streaming client executes the previous version of software program by using an executable page provider 310 having a structure, in S207.

If there is a new version, the streaming client receives update information including added or modified executable pages in a new version from streaming sever in S202, and modifies the structure of the executable page provider as shown in of FIG. 4b based on the newly-provided update information and the existing structure thereof, in S203.

Then, the streaming client checks whether the previous version of software program is executing in S204, and stands by until execution of the previous version of software program terminates in S205. When execution of the previous version of software program terminates, the streaming client deletes all information of the previous version which is necessary to execute only the previous version, and then modifies the structure of the executable page provider as shown in of FIG. 4c in S206. That is, there remains only the information of the new version of software program.

Accordingly, the invention can prevent generation of transmission overhead, minimize consumption of a storage area in order to store multiple versions of software program, and add a version of software program without having to interrupt the service of the software program.

While the present invention has been shown and described in connection with the exemplary embodiments and the accompanying drawings, it will be apparent to those skilled in the art that substitutions, modifications and variations can be made without departing from the spirit and scope of the invention.

1. A streaming client system comprising:
an executable page storage storing executable pages of a previous version only corresponded to the previous version or shared by the previous version and a new version, and executable pages added or modified in the new version; and
an executable page searcher searching and providing a necessary executable page with reference to executable pages of the previous version when a software program of the previous version is executed, and searching and providing the necessary executable page with reference to both the shared executable pages and the added or modified executable pages when the software program of the new version is executed.

2. The streaming client system of claim 1, wherein the executable page storage has:
the executable pages of the previous version being only corresponded to the previous version and being shared with the previous version and the new version;
streaming state information of the previous version informing streaming state of each of the executable pages of the previous version;
the added or modified executable pages of the new version being corresponded to the new version and added or modified with respect to the previous version; and
streaming state information of the new version informing streaming state of each of the shared executable pages and the added or modified executable pages.

3. The streaming client system of claim 1, wherein the executable page searcher includes:
a previous version executable page searcher searching and providing the necessary executable page with reference to the executable pages of the previous version to execute the software program the previous version; and
a new version executable page searcher searching and providing the necessary executable page with reference to both the shared executable pages and the added or modified executable pages to execute software program of the new version.

4. A streaming client system comprising:
an executable page storage storing executable pages shared by a previous version and a new version and executable pages added or modified in the new version;
an executable page searcher streaming the added or modified executable pages without concerning whether a software program of the previous version is executed and updating the software program to the new version according to the added or modified executable pages, after then searching and providing the necessary executable page in the shared executable pages and the added or modified executable pages when the software program of the new version is executed.

5. The streaming client system of claim 4, wherein the executable page storage has:
the executable pages of the previous being shared by the previous version and the new version;
the added or modified executable pages of the new version being corresponded to the new version and added or modified with respect to the previous version; and
streaming state information of the new version informing respective streaming state of the executable pages of the previous and the added or modified executable pages.

6. The streaming client system of claim 4, when there are executable pages corresponding to only the previous version, the executable pages corresponding to only the previous version are deleted in the state of software program termination.

7. A software version management method of a streaming client system, comprising:
in response to an update request for software program, without concerning whether a software program of a previous version is executed, sharing part of the executable pages of the previous version which are in common with a new version of software program, additionally streaming and storing executable pages added or modified in the new version; and
executing the previous version of software program with reference to the executable pages of the previous version or executing the new version with reference to both the shared executable pages and the added or modified executable pages.

8. The software version management method of claim 7 further comprises:
generating and initializing an executable page searcher and executable page streaming information of the previous version corresponding to the executable pages of the previous version;
connecting with a streaming server and receiving the executable pages of the previous version, streamed from the streaming server; and
registering the executable pages of the previous version in the executable page searcher of the previous version.

9. The software version management method of claim 8, wherein the step of sharing part of the executable pages of the previous version comprises:
generating and initializing an executable page searcher and executable page streaming information of the new version corresponding to both the shared executable pages and the added or modified executable pages, and reflecting information of the executable page searcher and executable page streaming information of the previous version to the initialized executable page searcher and executable page streaming information of the new version;
receiving only the added or modified executable pages, streamed from the streaming server; and
registering the added or modified executable pages in the executable page searcher of the new version.

10. A software version management method of a streaming client system, comprising:
in response to an update request for software program, without concerning whether a software program of a previous version is executed, sharing part of the executable pages of the previous version which are in common with a new version, additionally streaming and storing added or modified executable pages of the new version; and
deleting part of the executable pages of the previous version which are necessary for executing only the previous version after terminating execution of the previous version of software program.

11. The software version management method of claim 10 further comprises:
generating and initializing an executable page searcher and executable page streaming information of the previous version corresponding to the executable pages of the previous version;
connecting with a streaming server and receiving the executable pages of the previous version, streamed from the streaming server; and
registering the executable pages of the previous version in the executable page searcher of the previous version.

12. The software version management method of claim 11, wherein the step of sharing part of the executable pages of the previous version which are in common with a new version of software program, additionally streaming and storing executable pages added or modified in the new version comprises:
generating and initializing an executable page searcher and executable page streaming information of the new version corresponding to both the shared executable pages and the added or modified executable pages, and reflecting the executable page searcher and executable page streaming information of the previous version to the initialized executable page searcher and executable page streaming information of new version;
receiving only the added or modified executable pages, streamed from the streaming server; and
registering the added or modified executable pages in the executable page searcher of the new version.

13. The software version management method of claim 11, wherein the step of deleting part of the executable pages of the previous version comprises:
when the previous version of software program is executing, standing by until execution of software program is terminated; and
when the execution of software program is terminated, deleting the executable page searcher and executable page streaming information of the previous version which are necessary to execute only the previous version.
